(19) United States
(12) Patent Application Publication
(10) Pub. No.: US 2026/0189014 A1
(43) Pub. Date: Jul. 2, 2026

(54) POWER CONTROL SYSTEM FOR HOME ENERGY MANAGEMENT

(71) Applicant: FORD GLOBAL TECHNOLOGIES, LLC, Dearborn, MI (US)

(72) Inventors: Haider Mhiesan, Canton, MI (US); Timothy Harris, Grosse Ile, MI (US); Kirk Pulay, Belleville, MI (US); Christopher Bernard Trombetta, Commerce Township, MI (US)

(21) Appl. No.: 19/355,649

(22) Filed: Oct. 10, 2025

Related U.S. Application Data
(60) Provisional application No. 63/739,980, filed on Dec. 30, 2024.

(51) Int. Cl. H02J 3/38; H02J 3/32; H02J 13/12; H02J 13/13; H02J 13/34; H02J 101/24; H02J 105/12

(52) U.S. Cl. CPC H02J 3/381; H02J 3/322; H02J 13/12; H02J 13/1317; H02J 13/34; H02J 2101/24; H02J 2105/12

(57) ABSTRACT

A home energy system includes a distribution assembly with a power bus coupled to interfaces for a utility grid, home loads, distributed energy resources (DERs), and an electric vehicle (EV). Measurement circuitry obtains electrical parameters at the interfaces, and a power control system (PCS) controller monitors an aggregate parameter relative to a capacity constraint of the distribution assembly. When the aggregate exceeds the constraint, the PCS controller commands the DER or EV to reduce active power exchange. If the condition persists for an interval, the PCS controller actuates a relay switch to electrically isolate the DER or EV.

### CROSS-REFERENCE TO RELATED APPLICATION

This application claims the benefit of U.S. provisional application Serial No. 63/739,980 filed December 30, 2024, the disclosure of which is hereby incorporated in its entirety by reference herein.

### TECHNICAL FIELD

This disclosure relates to control of electrical power flow within an energy system.

### BACKGROUND

An electric vehicle may exchange power with a residential energy system through a charging interface.

### SUMMARY

The disclosure relates to a home energy system that includes a distribution assembly, such as a power bus, joined to a utility grid interface, a home load interface, a distributed energy resource (DER) interface, and an electric vehicle (EV) interface. Measurement circuitry obtains electrical parameters at each of these interfaces, including current values and, in some embodiments, voltage, frequency, or power factor. Relay switches are provided at least along the DER and EV interfaces, with an EV relay optionally positioned within an EVSE housing. A power control system (PCS) controller operates to monitor the aggregate of the measured parameters relative to a capacity constraint of the distribution assembly, which may correspond to a busbar ampacity rating or a threshold such as 120 percent of that rating. When the aggregate exceeds the capacity constraint, the PCS controller issues commands to reduce active power exchange by the DER or EV, whether by lowering EV charging consumption or by limiting DER or EV output. If the aggregate remains above the capacity constraint for an interval, the PCS controller actuates the appropriate relay switch to isolate the DER or EV. The PCS controller may be embodied within a HEMS enclosure, integrated into EVSE hardware, or housed in a standalone enclosure coupled electrically and communicatively to the distribution assembly.

The disclosure further relates to a power control system (PCS) adapted for use with a distribution assembly that interconnects a utility grid, home loads, distributed energy resources (DERs), and an electric vehicle (EV). The PCS includes an input interface that receives electrical parameter data, such as current, voltage, frequency, or power factor, obtained from measurement points along the distribution assembly. A controller processes the data to derive an aggregate electrical parameter representative of overall loading, and compares the aggregate against a capacity constraint value associated with the distribution assembly. When the aggregate exceeds the constraint, the controller issues a command to reduce active power exchange by the EV or DER. If the condition persists for an interval, such as within a range of 100 milliseconds to 10 seconds, the controller escalates the response by actuating a relay switch linked to the EV or the DER. In some embodiments, the relay associated with the DER is opened when the DER continues to export power after a curtailment command, while in other embodiments, the relay associated with the EV is opened when the EV continues to exchange power beyond the commanded limit. The input interface may receive data via dedicated measurement lines coupled to the distribution assembly, and the PCS may be embodied within a HEMS enclosure, integrated within EVSE hardware, or implemented as a standalone housing that communicates with the distribution assembly.

The disclosure also encompasses a method of controlling energy flow in a home energy system through supervisory action at a distribution assembly that interconnects a utility grid, home loads, distributed energy resources (DERs), and an electric vehicle (EV). The method includes evaluating electrical parameters obtained from the distribution assembly to derive an aggregate value representative of overall loading, and comparing that value to a capacity constraint associated with the distribution assembly. When the aggregate exceeds the constraint, a control command is issued to reduce active power exchange by at least one of the DER or the EV. In the case of the EV, the command may direct a reduction in power contribution when the vehicle is discharging, or a reduction in power consumption when the vehicle is charging. If the overload condition persists for an interval after such commanding, the method further includes actuating relay switches to physically isolate the relevant resource. In one implementation, a relay between the distribution assembly and the EVSE may be opened to disconnect the EVSE as a whole, while in another, a relay between the EVSE and the EV may be opened to disconnect the EV itself. By combining electronic curtailment commands with selective relay actuation, the method provides a layered process for maintaining operation of the home energy system within the ampacity limits of the distribution assembly.

### BRIEF DESCRIPTION OF THE DRAWINGS

FIG. 1 is a schematic diagram of a home energy system in which a home energy management system (HEMS) incorporates an integrated power control system (PCS) configured to interface with a utility grid, home loads, an electric vehicle, and distributed energy resources.

FIG. 2 is a schematic diagram of a home energy system in which an electric vehicle supply equipment (EVSE) incorporates an integrated power control system (PCS) configured to interface with a utility grid, home loads, an electric vehicle, and distributed energy resources.

FIG. 3 is a schematic diagram of a home energy system in which a standalone power control system (PCS) is deployed as an external module configured to interface with a utility grid, home loads, an electric vehicle, and distributed energy resources.

FIG. 4 is a graph illustrating example aggregate and contributor currents relative to a capacity constraint value over time within a home energy system.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

A home energy system may include a variety of energy-related components that operate together to supply electrical power to a residence. These components may include a utility grid connection, one or more locally installed power sources such as photovoltaic (PV) panels, a generator, a stationary battery, or a vehicle energy source, and one or more load centers or service panels that distribute power to appliances, lighting circuits, and other domestic loads. The system may further include power converters, relays, measurement circuits, and energy management components to coordinate the exchange of electrical energy between sources and loads. In some implementations, the system includes an electric vehicle (EV) and associated electric vehicle supply equipment (EVSE), allowing a traction battery of the EV to be charged from home energy sources or to supply energy to the home in a bidirectional configuration.

To facilitate intelligent coordination of these components, the system may include a Home Energy Management System (HEMS). The HEMS may operate as a centralized or distributed controller that monitors grid status, power flows, system voltage, and device activity to manage energy usage and availability. In addition to supporting normal operation, the HEMS may execute programmed responses to abnormal conditions such as grid outages or faults. These responses may include isolating loads, activating standby power sources, or initiating shutdown procedures for specific devices.

During grid-connected operation, electrical energy may be delivered to the home from a utility power source via an incoming service line. This energy may be routed through a main service panel or other distribution equipment to power various household loads. Local energy sources, such as solar photovoltaic systems, a generator, or a bidirectionally capable vehicle energy system, may also be connected within the home energy system. These sources may contribute energy to the home or export energy back to the grid, depending on system configuration and operating conditions. In many implementations, these sources are configured to operate in parallel with the grid and may synchronize to grid voltage and frequency when active. A supervisory control component, such as a home energy management system, may monitor grid status, energy consumption, and the availability of local sources in order to determine how best to utilize available energy. Under normal conditions, the control system may prioritize the use of grid power while selectively engaging local sources based on demand, pricing signals, or other control criteria. Components designed to operate during outage or backup scenarios may remain unpowered or in standby during this grid-connected mode.

When the utility grid becomes unavailable, the home energy system may enter a grid-loss or off-grid operating mode. In this state, grid-synchronized devices may cease operation, and the system may rely on local energy sources to maintain functionality. Depending on the implementation, the control system may detect the loss of grid voltage and initiate logic configured to assess which local sources are capable of continuing to provide power under off-grid conditions. Some sources, such as traditional grid-following photovoltaic inverters, may disconnect automatically in response to grid loss, while others, such as standby generators or appropriately configured energy storage systems, may continue to operate or may be activated by the control system. During grid-loss conditions, certain subsystems that remain inactive during grid-connected operation may become active to support autonomous operation and facilitate coordination of remaining energy assets.

Distributed energy resources (DERs) may be integrated into a home energy system to locally generate or store electrical energy for use by a residence. As used herein, the term “DER” refers to an on-site or nearby energy source or storage system capable of supplying electrical power to the home. DERs may include photovoltaic (PV) systems that convert solar energy into electrical power, combustion-powered generators configured to produce alternating current (AC) output, stationary batteries that store and discharge energy through power electronic interfaces, and electric vehicles (EVs) equipped with vehicle-to-home (V2H) functionality that enables an EV to supply energy back to the home, and/or vehicle-to-grid (V2G) functionality, in which power is delivered from the EV to the utility grid. These DERs may vary in their operating characteristics, such as whether they require synchronization with grid voltage or can operate independently, and whether they interface using direct current (DC) or AC connections.

One or more DERs may be connected to the home via an electric service panel, a home energy gateway, or a local load center. In certain implementations, each DER may be associated with one or more power electronics components, such as inverters, relays, and metering circuits, that condition its electrical output and control its connection to other system components.

While the characteristics of each DER may differ depending on its physical makeup and electrical design, these distributed energy contributors generally share the ability to provide at least some level of localized power to support residential loads. In certain embodiments, a DER may be configured to export power to the electric grid or to charge a vehicle or storage system. In other embodiments, a DER may be used primarily for backup power and remain inactive until a loss of grid connectivity is detected. Depending on the system architecture, a home may include a combination of active and standby DERs, with an energy management interface or supervisory logic coordinating their operation based on real-time needs.

The HEMS may be configured to monitor and coordinate the operation of DERs installed within the home energy system. These distributed energy sources can dynamically vary in availability and operational behavior depending on environmental conditions, load demands, and system state. The HEMS may identify which of these sources are active, idle, or in standby, and may selectively permit or restrict their contribution to the overall energy ecosystem based on system conditions. For example, when grid power is present, the HEMS may prioritize the use of grid energy and permit DERs to operate in parallel or remain offline; when grid power is lost, the HEMS may activate backup-capable DERs and initiate shutoff protocols for others.

To implement such coordination, the HEMS may track electrical parameters associated with each DER, such as output voltage, current, power factor, or frequency. In some examples, the HEMS may use predefined profiles to identify whether a DER operates in a grid-following or grid-forming mode, and tailor control actions accordingly. The HEMS may activate DERs in a staged or prioritized manner, delay or sequence their output, or issue operating commands through local control interfaces or networked communications.

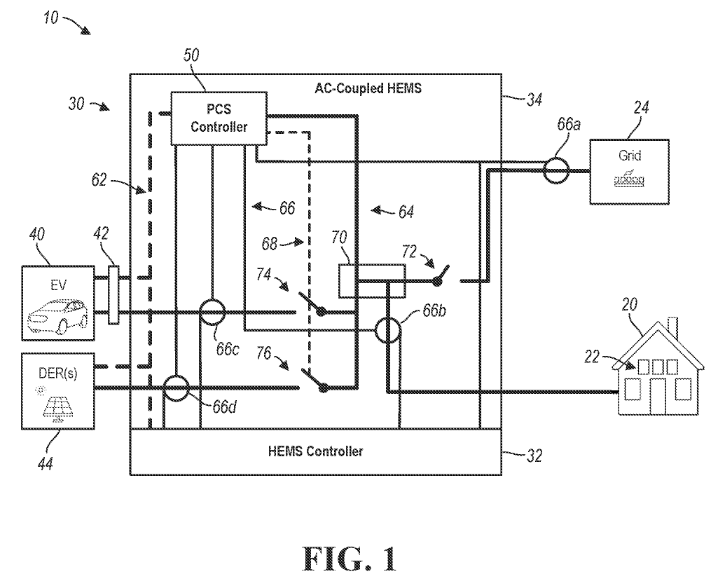

Referring now to FIG. 1, a home energy system (HES) 10 includes an integrated environment in which electrical power is exchanged between a utility grid 24, a home 20 or other building structure, an electric vehicle (EV) 40, and one or more distributed energy resources (DERs) 44. A home energy management system (HEMS) 30 coordinates operation of the system 10 and includes a HEMS controller 32 and a power control system (PCS) controller 50. As shown, the PCS controller 50 is arranged to monitor current and voltage conditions and control of power flows between the grid 24, the home 20 with its associated loads 22, the EV 40, and the DERs 44.

The home 20 represents a residential structure or other facility supplied by the HES 10. Within the home 20, electrical loads 22 are shown collectively to represent the various appliances, lighting circuits, climate control equipment, and other devices that consume power. The loads 22 may include both critical loads, which are designated for continued operation during limited-supply or backup conditions, and non-critical loads, which may be curtailed when system resources are constrained. The HEMS controller 32 and the PCS controller 50 are configured to monitor the overall demand of the loads 22 and coordinate power delivery from the grid 24, the EV 40, and the DERs 44 accordingly.

The utility grid 24 provides an external source of electrical power to the HES 10 and serves as the point of interconnection for importing or exporting energy. The grid 24 may supply power to the home 20 and its loads 22 under normal operating conditions, while also receiving surplus energy generated by the DERs 44 or discharged from the EV 40 when bidirectional operation is enabled. Current and voltage at the interface with the grid 24 may be measured by sensors associated with the PCS controller 50, permitting the PCS controller 50 to monitor operating conditions and to manage energy flows so as to maintain compatibility with grid requirements without excessive current draw.

The HEMS 30, also referred to as a “HEMS hub,” acts as a centralized integration and coordination point for external and local energy resources of the home energy system 10. The HEMS 30 may include, for example, various control, sensing, and switching components configured to evaluate electrical conditions and influence system behavior.

In some implementations, the HEMS 30 may be embodied in a unitary housing or enclosure 34, often referred to as a “combiner box”, that physically houses the major control and power-handling components of the home energy management system. This enclosure 34 may be weatherproof, thermally managed, or segmented to separate high-voltage and low-voltage compartments. The enclosure 34 includes pass-through or grommeted cable routing for accommodating L1, L2, Neutral, and ground conductors, along with low-voltage wiring for battery connections, control signals, and communications. Internally, the enclosure 34 may include mechanical structures for mounting and securing components, as well as provisions for electrical interconnection, heat dissipation, and environmental protection. For example, the enclosure may include one or more compartments, internal mounting rails, or backplanes configured to support components such as the HEMS controller 32, PCS controller 50, other control circuitry, memory, and communication interfaces. The enclosure 34 may also house a HEMS inverter and a dark start battery in a compact and coordinated arrangement. Enclosure features may also include printed circuit boards, high-voltage busbars, DC and AC wiring terminals, relays, sensors, fuses, communication ports, and other electronic components for integrating the system into the broader home electrical infrastructure.

In other configurations, components of the HEMS 30 may be physically distributed rather than housed within a single enclosure. For instance, the one or both of the HEMS controller 32 and the PCS controller 50 may be housed in separate enclosures or located in a different areas of the premises. Likewise, a dark start battery or HEMS inverter may be located externally to reduce enclosure size, support user-replaceability, or meet certain thermal or spatial design considerations. In these distributed implementations, the components may be electrically coupled via appropriate wiring harnesses, communication links, or power bus interfaces to maintain integrated system functionality.

An EV 40 is coupled to the home energy system 10 through electric vehicle supply equipment (EVSE) 42. The EVSE 42 provides an interface between the EV 40 and the HEMS 30, enabling charging of the EV battery and, in some embodiments, bidirectional transfer of power from the EV 40 back into the system. Current and voltage associated with the EV 40 and EVSE 42 may be monitored by the PCS controller 50, as described in greater detail herein.

In some implementations, the EV 40 and associated EVSE 42 may serve not only as a load during charging operations, but also as a DER 44 capable of supplying power to the home 20 or grid 24. For example, a bidirectional EVSE 42 may enable vehicle-to-home (V2H) functionality, in which a traction battery of the EV 40 delivers energy into the home energy system 10, or vehicle-to-grid (V2G) functionality, in which the traction battery delivers energy to the grid 24 under control of the PCS controller 50.

The DERs 44 represent one or more local generation or storage assets coupled to the home energy system 10. In the example of FIG. 1, the DERs 44 may include a solar photovoltaic (PV) system, although other resources such as generators, battery energy storage systems (BESS), fuel cells, or microturbines may also be used. Further, as discussed, EVs having bidirectional interfaces may operate as DERs 44. The DERs 44 contribute power to the home 20 and its loads 22, and in some cases supply energy back to the grid 24. The PCS controller 50 is configured to receive current and voltage measurements associated with the DERs 44, enabling the PCS controller 50 to coordinate operation of these resources, curtail generation when required, or disconnect a resource through relay control if abnormal conditions are detected.

The PCS controller 50 functions as a supervisory and control layer within the HEMS 30, providing monitoring, decision-making, and actuation capabilities that govern how energy is exchanged among the grid 24, the loads 22, the EV 40, and the DERs 44. The PCS controller 50 processes input from current and voltage sensors located at various points in the system and produces output signals to adjust active power, control charge or discharge rates, or actuate relays for isolation of devices. In this manner, the PCS controller 50 supports continuous balance of power flows, mitigation of overcurrent conditions, and coordination of multiple resources operating on a common electrical bus.

More particularly, the PCS controller 50 is configured to coordinate operation of the system 10 based on measured electrical conditions and predefined control logic. The PCS controller 50 may include processing hardware, memory, and associated software or firmware instructions enabling it to execute logic routines, reference stored action tables, and initiate control responses. These responses may include controlling relays, influencing load distribution, initiating isolation (e.g., DER or transformer isolation), or communicating with other system components such as DERs or vehicle charging interfaces. The PCS controller 50 may monitor parameters such as transformer temperature, current draw, and voltage drop, either directly or through associated sensors, and may determine whether one or more predefined values, thresholds, or combinations of conditions are met.

While the PCS controller 50 is illustrated as being integrated within the HEMS enclosure 34 in FIG. 1, as will be appreciated, the PCS controller 50 may be positioned elsewhere within the home 12 or may be remote from the premises altogether. For example, certain aspects of the control logic may be executed by a cloud-based platform, with the PCS controller 50 operating as a distributed control system that coordinates local measurements and actions with remote decision-making resources. This flexibility allows the control functions associated with system monitoring and load coordination to be implemented using a variety of hardware topologies, including configurations with centralized, decentralized, or hybrid control architectures.

The PCS controller 50 may include processing hardware configured to operate in conjunction with a memory storing logic routines, parameter values or thresholds, and other control instructions. The memory may comprise a non-transitory computer-readable medium storing instructions that, when executed by the PCS controller 50, cause it to perform the control and coordination operations described herein. These operations may include initiating transformer isolation, influencing load distribution, or controlling relays based on measured electrical conditions.

The memory may reside locally within the same housing as the PCS controller 50, such as within the HEMS enclosure 34, or may be located remotely and accessed via wired or wireless communication. In some implementations, the memory may be cloud-accessible, enabling updates to control logic or threshold values over time. Regardless of location, the memory provides the programmable basis for the system’s decision-making capabilities. In this way, upon determining one or more predefined values, thresholds, or combinations of conditions are satisfied, the PCS controller 50 may initiate actions stored in the memory.

The PCS controller 50 may serve as a central signaling and control platform, interfacing with other components in system 10 as well as external or remote entities. More particularly, PCS controller 50 may include or be operatively coupled to a communication interface configured to enable data exchange between the PCS controller 50 and other system components. For example, the PCS controller 50 may be communicatively connected to the EVSE 42 or DER 44 to receive operational status, power availability, or charging readiness signals. In embodiments where vehicle state of charge (SOC) data is made available to the system 10, the PCS controller 50 may receive such information from the EVSE 42 and determine whether to enable or delay charging. The PCS controller 50 may also coordinate energy flow logic by activating or deactivating system relays in response to changing DER output, vehicle connection status, or homeowner-specified operating modes.

The communication interface may support wired or wireless communication protocols, and may be used to receive updated control logic, action tables, or firmware updates from a cloud-based service. In some implementations, the communication interface also facilitates interaction with a mobile application or utility server. In configurations supporting cloud-based functionality, the communication interface may maintain a data link between the PCS controller 50 and a remote server environment. This connectivity may allow operational data, such as transformer loading trends, control actions taken, or threshold event histories, to be uploaded for long-term storage, analytics, or diagnostic purposes. In some cases, the cloud platform may support system updates, allowing the PCS controller 50 to receive revised logic structures or updated firmware.

In some implementations, the HEMS controller 32 and the PCS controller 50 may operate in a cooperative arrangement in which each contributes to overall system management. The HEMS controller 32 may serve as a higher-level coordination platform, managing homeowner preferences, scheduling inputs, or communications with external entities such as a utility server. The PCS controller 50, by contrast, may perform supervisory monitoring and real-time actuation associated with the energy flows through relays, chargers, and distributed resources. In this cooperative configuration, the HEMS controller 32 may continuously supply the PCS controller 50 with status data, operating constraints, or mode selections, while the PCS controller 50 returns operational feedback such as load conditions, event detections, or actuator states. The exchange of data between the HEMS controller 32 and PCS controller 50 allows the two control layers to balance energy supply and demand in a coordinated manner, while still permitting either controller to initiate protective responses if measured parameters exceed a predefined condition.

In this way, the system 10 includes one or more communication lines 62 that provide a signaling pathway between the PCS controller 50 and the HEMS controller 32. In the example illustrated, communication lines 62 further extend by way of branch connections to the EV 40 (via the EVSE 42) and to the DER 44. Through this arrangement, the PCS controller 50 and the HEMS controller 32 may exchange data such as operating status, electrical measurement values, or control instructions, while also receiving information from or transmitting commands to connected resources. Communication lines 62 may be implemented using any suitable wired or wireless protocol, and may support bi-directional data flow that accommodates system monitoring, coordination of switching events, and transmission of configuration updates.

In some embodiments, the communication lines 62 may function as a universal interface for coordinating interactions among the PCS controller 50, the HEMS controller 32, and various distributed energy resources. By employing a common communication channel rather than device-specific connections, the system 10 may reduce integration complexity while maintaining flexibility to support different resource types, such as photovoltaic systems, vehicle charging equipment, energy storage devices, or backup generation units. This approach provides a modular basis for system expansion, enabling additional resources to be coupled to the HEMS 30 without requiring fundamental redesign of communication infrastructure. The universal nature of communication lines 62 thereby facilitates scalability and interoperability across a variety of configurations, facilitating incorporation of future devices and control strategies into the overall architecture.

The system 10 further includes power lines 64, which provide the primary electrical pathways interconnecting the various components of the home energy system 10. The power lines 64 couple the utility grid 24, the HEMS 30, the EV 40 through the EVSE 42, the DERs 44, and the household loads 22. Depending on implementation, the power lines 64 may include feeders, busbars, branch conductors, or other conductive elements configured to carry electrical current. These conductors define the physical medium through which active power is exchanged among the sources and sinks in system 10. As used herein, the term power lines 64 is intended to broadly encompass the electrical conductors of the system, and may be distinct from the communication lines 62, measurement lines 66, or control lines 68, which serve different signaling or monitoring functions.

In association with the power lines 64, the system 10 further includes a distribution assembly 70 that serves as a common junction point for the interconnected pathways. The distribution assembly 70 aggregates current from the utility grid 24, the household loads 22, the EV 40, and the DERs 44, thereby providing a conductive node at which the major interfaces of the system converge. In one embodiment, the distribution assembly 70 may be embodied as a bus bar within the HEMS enclosure 34, although other conductive structures such as terminal blocks, bus plates, or printed circuit board traces may alternatively be used. In multi-phase implementations, the distribution assembly 70 may comprise multiple bus sections arranged to separately conduct respective phase currents.

The distribution assembly 70 defines the locus at which electrical parameters of the system are summed or otherwise collectively constrained. Because the current-carrying capacity of the distribution assembly 70 is finite, the aggregate electrical parameter monitored by the PCS controller 50 may be evaluated relative to a capacity constraint value associated with this assembly. For example, when currents supplied by the DERs 44 and the EV 40, in combination with or in place of grid-sourced current, would result in a loading condition above the rated ampacity of the distribution assembly 70, the PCS controller 50 may command a reduction in active power exchange or initiate relay actuation to prevent overcurrent. In this way, the PCS controller 50 treats the distribution assembly 70 as a control boundary for coordination of resources within the home energy system 10.

The system 10 may further include one or more measurement lines 66 that provide electrical feedback from the power lines 64 to the PCS controller 50. These measurement lines 66 can be implemented through various sensing devices, such as current transformers, Hall-effect sensors, or voltage sensing taps, positioned to capture real-time operating data. While current may be a primary parameter of interest in the illustrative examples, the measurements may also include voltage, frequency, phase angle, or derived values such as apparent power, real power, or power factor. The signals delivered along the measurement lines 66 allow the PCS controller 50 to assess operating conditions within the home energy system 10 at multiple connection points throughout the system 10.

In some embodiments, the measurement lines 66 may include several representative connections. A first measurement line 66a may be coupled to the incoming utility connection, providing feedback corresponding to the grid current and related parameters. A second measurement line 66b may be positioned along the branch feeding the home loads 22, downstream of the grid relay and within the HEMS 30, and may supply feedback both to the PCS controller 50 and to the HEMS controller 32. A third measurement line 66c may be positioned along the branch serving the EV 40 through the EVSE 42, downstream of the EV relay, again forwarding signals to the PCS controller 50 and HEMS controller 32. A fourth measurement line 66d may be positioned along the branch connecting to the DER 44, downstream of the DER relay and within the HEMS 30, with corresponding feedback similarly delivered to the PCS controller 50 and HEMS controller 32.

The PCS controller 50 may process the signals obtained from the measurement lines 66 on a continuous or periodic basis. By monitoring parameters at each of these locations, the PCS controller 50 can establish a detailed representation of system loading, DER output, and overall power balance. This information may be compared against predefined values, thresholds, or conditions, and may be used to guide responsive actions such as adjustment of power flow, modification of dispatch commands, or selective actuation of relays. In some cases, the measurements may further be used in coordination with the HEMS controller 32 to support broader home energy management functions. In some embodiments, the measurement strategy may extend beyond fixed connection points to encompass a distributed or modular approach. Additional branches of the power lines 64 may be instrumented as needed, with the PCS controller 50 configured to accept and interpret modular feedback inputs.

In association with the power lines 64, the system 10 further incorporates a set of relay switches that define controllable interfaces between the HEMS 30 and external energy components. More particularly, relay 72 provides a switchable connection between the HEMS 30 and the utility grid 24, relay 74 governs the coupling between the HEMS 30 and the EV 40 through the EVSE 42, and relay 76 manages the electrical connection to the DERs 44. These relays form an intermediary layer between the conductive pathways of the power lines 64 and the supervisory logic of the PCS controller 50, enabling the system to dynamically include or exclude resources in response to observed operating conditions. In this way, the relays serve not only as protective elements but also as configurable gateways that support flexible integration, isolation, or prioritization of available resources.

In conjunction with the relays 72, 74, 76, the system 10 incorporates one or more control lines 68 that extend between the PCS controller 50 and the relays. These control lines 68 provide the signaling pathways through which the PCS controller 50 issues actuation commands to open or close the respective relays in accordance with system logic. In certain embodiments, the control lines 68 may comprise hardwired electrical connections that transmit discrete control signals, while in other embodiments the lines may include digital communication channels capable of carrying command instructions, relay status acknowledgments, or diagnostic information. By linking the supervisory intelligence of the PCS controller 50 to the mechanical switching functions of the relays, the control lines 68 establish a responsive interface that allows the HEMS 30 to dynamically manage the interconnection of the grid 24, EV 40, and DERs 44 to the power lines 64.

The electrical interconnections shown in FIG. 1 are configured to enable energy exchange among the utility grid 24, the EV 40, the DER 44, and the home 20 under a range of operating conditions. During standard grid-connected operation, relay 72, which forms a controllable switching interface between the grid 24 and the rest of the system 10, may remain in a closed state, allowing grid power to flow into the HEMS 30 and, from there, be distributed to household loads 22, charge energy storage systems, or supply power to the EV 40 via the EVSE 42. The PCS controller 50 may continuously monitor electrical parameters associated with the grid connection, such as voltage, frequency, or current flow, using measurement circuitry or auxiliary sensors.

When a grid-loss condition is detected (e.g., due to grid outage or intentional grid disconnection), the PCS controller 50 may initiate a transition to off-grid operation. This transition may include opening relay 72 to electrically isolate the home energy system 10 from the external grid 24. Such disconnection may allow continued use of grid-forming components. The opening of relay 72 also serves as a logical trigger for other HEMS logic modules, such as evaluation of DER behavior, initiation of backup power sources, or voltage-based coordination actions discussed in greater detail herein. When grid power is restored and verified to be stable, the PCS controller 50 may re-close relay 72 and resume grid-synchronized operation in a coordinated manner.

Relay 74, positioned between the EVSE 42 and the HEMS 30, provides a controllable electrical connection under the supervision of the PCS controller 50. In some implementations, the EV 40 may be configured for bidirectional power transfer, allowing its traction battery to be charged from the home or, alternatively, to discharge power back into the system in a vehicle-to-home (V2H) mode or vehicle-to-grid (V2G) mode.

The PCS controller 50 may selectively open or close relay 74 to enable or prevent the EV 40 from contributing to or drawing energy from the home energy system 10. During grid-connected operation, the PCS controller 50 may close relay 74 to allow the EV 40 to receive grid power for vehicle charging. In other cases, such as when grid power is unavailable or the system 10 has transitioned to a backup operating mode, the PCS controller 50 may assess whether the EV 40 can serve as an available local power source. If the EV 40 supports V2H capability and sufficient charge is present, the PCS controller 50 may close relay 74 and configure the EVSE 42 to deliver energy into the home 20 or to support voltage-based DER control functions. In implementations without bidirectional capability, the PCS controller 50 may open relay 74 to inhibit vehicle load from interfering with other system priorities or to preserve stored energy within the EV 40.

Relay 76 governs the electrical coupling between the DER 44 and the remainder of the home energy system 10, enabling the PCS controller 50 to dynamically include or exclude the DER 44 from active participation based on operating conditions. Relay 76 may be used to isolate DER 44 during startup, shutdown, or fault conditions. Under normal grid-connected conditions, the PCS controller 50 may monitor the output of DER 44 and determine whether to activate relay 76 in coordination with other energy components. In some implementations, DER 44 may operate in a grid-following mode, synchronizing to grid voltage and frequency when connected. If a grid loss event is detected, the PCS controller 50 may observe whether DER 44 responds appropriately, such as by ceasing output. If the DER 44 continues operating when it should not, the PCS controller 50 may initiate countermeasures as discussed further herein.

When the system operates in a grid-outage mode, relay 76 allows the PCS controller 50 to reconnect DER 44 when such operation is appropriate. In systems where DER 44 includes grid-forming capabilities (e.g., a generator or configured storage system), the PCS controller 50 may use relay 76 to integrate the DER 44 into a microgrid-type configuration for continued operation. In contrast, if the DER 44 is identified as misbehaving under off-grid conditions (e.g., continuing to export power when not intended), the PCS controller 50 may keep the relay 76 open to prevent unintended power flows or to protect downstream equipment.

In the example shown, the PCS controller 50 is operatively coupled to each of relays 72, 74, and 76 and may transmit control signals to open or close these relays 72, 74, 76 in response to detected conditions. In this way, the PCS controller 50 may selectively isolate or connect external sources, such as the grid 24, the EV 40, or the DER 44, depending, for example, on whether these components are available, needed, or misbehaving. The PCS controller 50 may also monitor system-level parameters such as AC line voltage, current flow, and frequency to evaluate grid availability, load demand, and source performance. This supervisory control enables the PCS controller 50 to enforce system protection logic, coordinate source prioritization, and trigger responses such as the relay control described in greater detail herein.

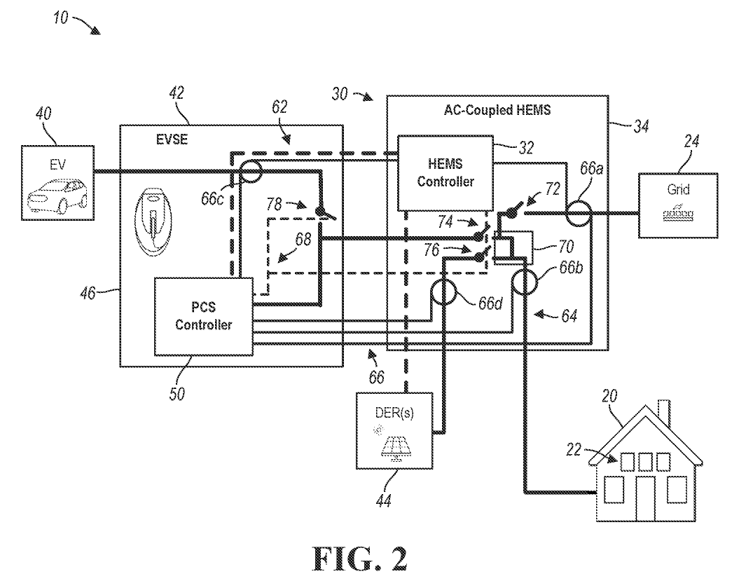

FIG. 2 illustrates another embodiment of a home energy system 10. In many respects, the architecture of system 10 remains similar to that described with reference to FIG. 1, incorporating the home 20 and its associated loads 22, the utility grid 24, the HEMS 30 with controller 32, the EV 40 coupled through EVSE 42, and one or more distributed energy resources (DERs) 44. The principal distinction is the placement of the power control system (PCS) 50, which in this embodiment is integrated within the EVSE 42 rather than within the HEMS 30.

By locating the PCS 50 in the EVSE 42, the EVSE 42 performs not only conventional charging functions but also supervisory control functions typically attributed to the HEMS enclosure. Thus, the HEMS controller 32 remains disposed within the HEMS 30, while the PCS controller 50 is co-located with the housing 46 of the EVSE 42. This arrangement preserves the overall connectivity of system 10 while redistributing control intelligence to a critical interface point between the EV 40, the grid 24, and the HEMS 30.

The conductive pathways of the power lines 64 remain configured to connect the grid 24, the home 20, the EV 40, and the DERs 44. In the embodiment of FIG. 2, however, the PCS 50 integrated in the EVSE 42 governs actuation of relays 72, 74, and 76 via control signaling. These relays continue to define switchable interfaces between the HEMS 30 and external resources, but the governing commands may now originate from the EVSE-based PCS controller 50 rather than from a controller positioned within the HEMS enclosure 34.

In addition to these system-level interfaces, FIG. 2 further illustrates a dedicated EV relay 78 positioned within the EVSE housing 46. Relay 78 is configured to selectively couple or decouple the EV 40 from the EVSE 42 under the supervisory command of the PCS controller 50. Whereas relay 74 manages the broader interface between the HEMS 30 and the EVSE 42, the EV relay 78 provides an additional layer of selectivity within the EVSE itself, thereby supporting finer-grained control over vehicle charging and discharging operations.

Communication line 62 continues to provide signaling between the PCS controller 50 and the HEMS controller 32, notwithstanding the physical relocation of the PCS into the EVSE 42. In addition, the measurement lines 66 provide electrical feedback representative of current, voltage, or related parameters. Depending on the implementation, such measurement lines may terminate directly at the PCS controller 50 in the EVSE 42, or may route through the HEMS 30 to supply data to both controllers. In the embodiment of FIG. 2, the EV current sensing (illustrated at 66c) may occur at the EVSE 42 (e.g., within the EVSE housing 46) rather than at the HEMS 30, further demonstrating that measurement functionality may be physically distributed across enclosures without loss of integration.

Functionally, the embodiment of FIG. 2 preserves the cooperative relationship between the PCS controller 50 and the HEMS controller 32. The HEMS controller 32 may continue to perform higher-level coordination of energy supply and demand across the system 10, while the PCS controller 50 integrated in the EVSE 42 delivers localized monitoring and actuation capability. The placement of the PCS controller 50 at the EV interface may provide practical advantages, such as consolidating supervisory functions at a critical node where bi-directional energy exchange frequently occurs.

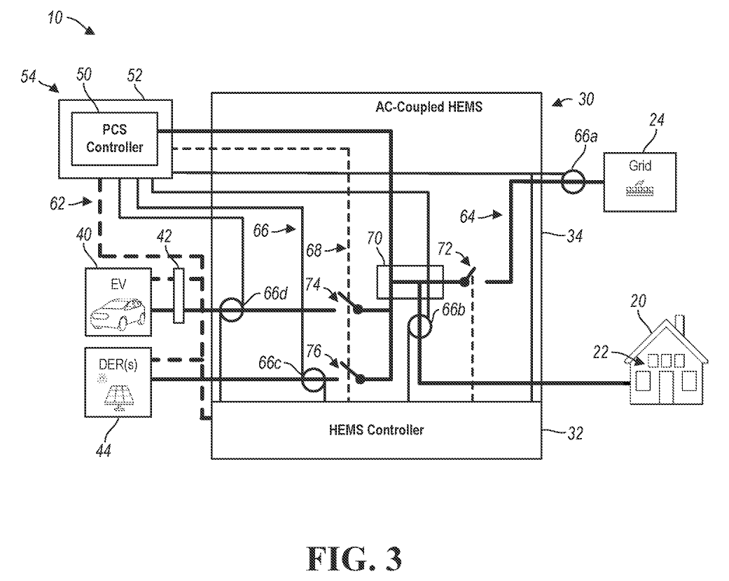

From an architectural standpoint, this embodiment highlights the modularity of the PCS controller 50. By supporting integration into the EVSE 42, the PCS controller 50 may be deployed selectively at different nodes within the system 10, without requiring modification of the HEMS enclosure 34. Such flexibility underscores the universal character of the PCS architecture, enabling it to be incorporated into the HEMS 30 (FIG. 1), into the EVSE 42 (FIG. 2), or into a standalone unit (FIG. 3).

FIG. 3 illustrates another embodiment of the home energy system 10, in which the power control system (PCS) 50 is configured as a standalone unit. In this embodiment, the system again incorporates the home 20 with its associated loads 22, the utility grid 24, the HEMS 30 with controller 32, the EV 40 connected through EVSE 42, and one or more distributed energy resources (DERs) 44. Rather than being housed within the HEMS enclosure 34 or the EVSE 42, the PCS controller 50 is provided in its own dedicated enclosure 52 that interfaces with the power lines 64 and communicates with the HEMS controller 32.

In this configuration, the standalone PCS controller 50 and housing 52, collectively referred to as PCS 54, occupies an intermediate position within the system architecture, electrically and communicatively linked to the HEMS 30, the grid 24, the home 20, the EV 40, and the DERs 44. The PCS 54 incorporates its own controller capable of monitoring operating conditions and actuating relays 72, 74, and 76 via control lines 68, in order to connect or disconnect external resources as required. By being physically and functionally independent, the PCS 54 may be retrofitted into existing systems or deployed in contexts where integration into the HEMS 30 or EVSE 42 is not feasible.

The communication line 62 in this embodiment extends between the PCS 54 and the HEMS controller 32, preserving cooperative operation between the two supervisory entities. Similarly, the measurement lines 66 extend to the PCS 54 to provide feedback of electrical parameters such as current, voltage, frequency, or related values at key points of the power lines 64. The standalone PCS 54 may therefore receive direct sensing data while also coordinating with the HEMS controller 32 to align local responses with overall system objectives.

Functionally, the standalone PCS 54 executes supervisory tasks similar to those described with reference to FIGS. 1 and 2. The PCS controller 50 continuously evaluates measurement feedback, applies threshold logic, and issues control signals to the relays 72, 74, and 76. In coordination with the HEMS controller 32, the PCS 54 may implement strategies for balancing supply and demand, managing power flows to or from the EV 40, or isolating misbehaving DERs 44.

Architecturally, the embodiment of FIG. 3 emphasizes the adaptability of the PCS controller 50. By existing as an independent, self-contained module 52, the PCS 54 can be deployed in a wide variety of system contexts without reliance on a particular host component such as the HEMS enclosure 34 or EVSE 42. This universality provides an opportunity for uniform control logic across diverse installations, while allowing flexibility in physical placement according to system design or retrofit considerations.

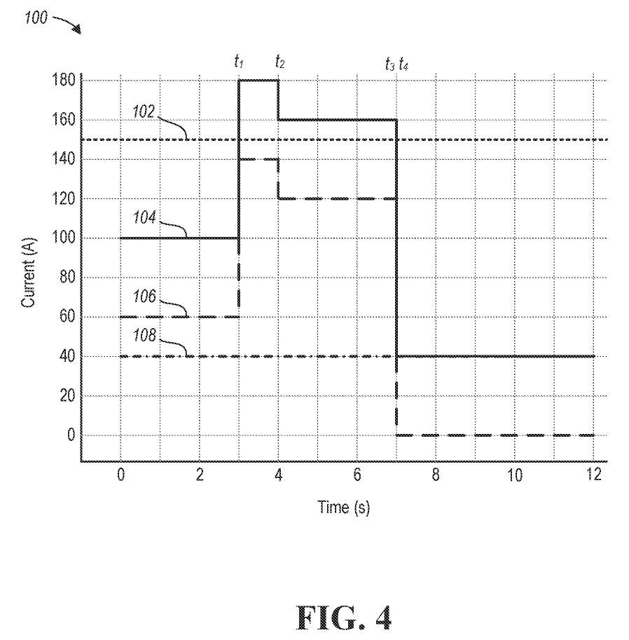

FIG. 4 illustrates an example operational graph 100 of current versus time within the home energy system 10. The vertical axis represents electrical current, expressed in amperes (A), and the horizontal axis represents elapsed time, expressed in seconds (s). A horizontal line 102 denotes a capacity constraint value (CCV) that reflects an upper limit associated with the distribution assembly 78. Trace 104 represents an aggregate current exchanged over the distribution assembly 78, while traces 106 and 108 represent individual contributions from two distinct energy resources. The aggregate trace 104 generally corresponds to the sum of the contributor traces 106, 108.

In the example shown, the system begins with both contributors 106 and 108 operating at baseline levels, such that the aggregate current 104 remains below the CCV 102. At a first moment t₁, contributor 106 increases its current output, causing the aggregate current 104 to rise above the CCV 102. At a subsequent moment t₂, the PCS controller 50 issues a command to reduce the active power exchange of contributor 106. This results in a partial reduction in current by contributor 106, with a corresponding decrease in aggregate current 104, although the aggregate remains above the CCV 102. At time t₃, the predetermined persistence interval expires. Upon expiration or shortly thereafter, at time t₄, the PCS controller 50 actuates an associated relay switch to electrically isolate contributor 106 from the distribution assembly 78. The current associated with contributor 106 thus drops to zero, and the aggregate current 104 falls below the CCV 102.

In one scenario, contributor 106 represents a distributed energy resource such as a photovoltaic array. A sudden increase in irradiance may cause the DER to surge output, raising the aggregate current 104 above the CCV 102. The PCS controller 50 may issue a curtailment command to reduce DER output. If the reduction is insufficient to restore the aggregate current 104 below the CCV 102 within the persistence interval, the controller may actuate a relay to disconnect the DER from the distribution assembly 78.

In another scenario, contributor 106 represents an electric vehicle undergoing charging. A rapid increase in charging current, for example due to a transition to fast-charge mode, may cause the aggregate current 104 to exceed the CCV 102. The PCS controller 50 may issue a command to limit charging rate. If the EV continues to draw above-threshold current, the PCS controller 50 may isolate the EV by opening a relay within an associated EVSE. In some cases, the controller may instead disconnect the DER to preserve priority for the EV charging function.

In a further example, contributor 106 may represent an EV while contributor 108 represents a DER. Under such conditions, the PCS controller 50 may attempt to balance current by influencing load distribution or coordinating with the HEMS controller 32. If aggregate current 104 remains above the CCV 102 despite such balancing efforts, the controller may proceed to open a relay to shed one of the contributors.

Another implementation includes a hysteresis-based evaluation. In this implementation, a reduction command at time t₂ may lower the aggregate current 104 to a value just under the CCV 102. The PCS controller 50, however, may apply a secondary threshold lower than the CCV 102, and continue to monitor until this hysteresis threshold is satisfied. If the aggregate current 104 does not fall sufficiently below the CCV 102, the persistence interval may continue to run, and the relay actuation at t₄ may still occur to ensure stability.

In yet another variation, the PCS controller 50 may apply selective isolation rules. For instance, even if the EV is the contributor associated with the spike, the controller may open the relay for the DER instead, based on programmed priorities, user preferences, or other requirements. This flexibility allows the PCS controller 50 to relieve stress on the distribution assembly 78 while maintaining continuity of a higher-priority function such as EV charging.

The current magnitudes and time intervals shown in FIG. 4 are illustrative only. For example, the CCV 102 may be established at a value corresponding to a busbar ampacity rating or a threshold such as 120 percent of that rating. Likewise, the persistence interval represented between t₂ and t₃ may vary depending on the control logic, and the separation between t₃ and t₄ may represent either concurrent or slightly offset events. The current reductions may occur in stepwise fashion as illustrated, or may follow a ramped profile depending on the system implementation.

In another aspect, the disclosure contemplates a method of controlling energy flow in a home energy system. The method operates within or in conjunction with a distribution assembly 70, which may be embodied as a bus bar or other conductive junction electrically coupled to a utility grid interface, a home load interface, a DER interface, and an EV interface. The distribution assembly 70 provides a common point of aggregation for electrical currents flowing among these interfaces.

The method includes monitoring electrical conditions along the distribution assembly 70. In some implementations, measurement circuitry 66 obtains electrical parameter data such as current, voltage, frequency, or power factor at the grid interface, the home load interface, the DER interface, and the EV interface. Current sensors may be positioned at each of these locations to generate feedback signals, and additional sensors may capture voltage or frequency information. These measurements are communicated to a PCS controller 50 or equivalent supervisory logic.

From the collected data, the PCS controller 50 determines an aggregate electrical parameter representative of loading on the distribution assembly 70. The aggregate parameter may include, for example, a sum of phase currents, an RMS current, or another derived electrical quantity. This aggregate parameter is evaluated against a capacity constraint value corresponding to the distribution assembly’s rated ampacity. In some cases, the capacity constraint dictates that combined source currents do not exceed 120% of the busbar’s rated capacity.

When the aggregate parameter exceeds the capacity constraint value, the method includes initiating a command to reduce active power exchange with the distribution assembly 70. The PCS controller 50 may issue a command to a DER 44 to curtail active power output, such as reducing photovoltaic generation or limiting battery discharge. In other embodiments, the PCS controller 50 may issue a command to an EV 40. Such a command may reduce active power consumption when the EV 40 is charging, or reduce active power contribution when the EV 40 is discharging back into the system (e.g., during vehicle-to-home or vehicle-to-grid operation).

If the aggregate parameter remains above the capacity constraint value, the method further includes evaluating whether the excess condition persists for a predetermined interval. The predetermined interval may be selected to range between about 100 milliseconds and 10 seconds, or other appropriate ranges depending on implementation. This interval allows the PCS controller 50 to differentiate between transient fluctuations and sustained overload conditions.

Upon determining that the aggregate parameter has persisted above the capacity constraint value for the predetermined interval, the PCS controller 50 escalates the response by actuating one or more relay switches. In one embodiment, a DER relay 76 is opened to electrically isolate the DER 44 from the distribution assembly. In another embodiment, an EVSE relay 74 is opened to isolate the EVSE 42 from the distribution assembly. In still another embodiment, an EV relay 78 positioned within the EVSE housing is opened to electrically isolate the EV 40 from the EVSE 42. These relays provide a physical disconnect when electronic curtailment commands are insufficient to relieve the overload condition.

The method can be adapted depending on where the PCS controller 50 is physically located. In one embodiment, the PCS controller 50 is housed within a HEMS enclosure 34 and directly drives DER and EV relays. In another embodiment, the PCS controller 50 is integrated into the EVSE 42, in which case it may command both the EV relay within the EVSE and upstream relays between the distribution assembly and the DER interface. In yet another embodiment, the PCS controller 50 is provided in a standalone housing 52 coupled by communication, measurement, and control lines to the distribution assembly 70.

Throughout this process, the PCS controller 50 may operate cooperatively with a HEMS controller 32. For instance, the HEMS controller 32 may maintain responsibility for actuating the grid relay 72, while the PCS controller 50 manages DER and EV relays. Communication between the PCS and HEMS controllers may support coordinated control logic, such as prioritizing critical loads or balancing supply and demand across available resources.

Taken together, this approach provides a layered control process in which the PCS controller 50 first attempts to mitigate overload by commanding DERs or EVs to reduce active power exchange, and then escalates to physical isolation using relay switches if overload conditions persist. By evaluating electrical parameters relative to a capacity constraint of the distribution assembly 70, and by applying thresholds consistent with requirements such as the 120% criteria discussed above, the method enables coordinated operation of a home energy system across a variety of physical deployment configurations.

The algorithms, methods, control routines, and processes disclosed herein may be implemented or carried out by a computer, controller, or other processing device, which may include a dedicated electronic control unit (ECU), a programmable ECU, a microcontroller, or a general-purpose processor operating under stored instructions. These instructions and data may be embodied in a variety of machine-readable storage media, including non-writable media such as read-only memory, as well as writable or reprogrammable media such as random access memory, flash memory, optical discs, or magnetic storage devices. In some embodiments, the disclosed functions may be executed as software or firmware objects that interact with system hardware to carry out the supervisory or control logic described. In other embodiments, the algorithms or processes may be embodied in whole or in part using dedicated hardware elements such as application-specific integrated circuits (ASICs), programmable logic devices, field-programmable gate arrays (FPGAs), or discrete state machines. Hybrid approaches including combinations of hardware, firmware, and software may also be used. Accordingly, the functions attributed to the PCS controller 50, the HEMS controller 32, or related control modules may be realized in a wide variety of computational platforms or control architectures.

The exemplary embodiments and configurations described above are presented by way of illustration rather than limitation, and are not intended to exhaustively enumerate every form that the inventive subject matter may take. The terminology utilized in the specification is intended to be descriptive in nature, rather than restrictive, and it will be understood by those of ordinary skill in the art that modifications, substitutions, or rearrangements of described components, steps, or structures may be made without departing from the scope provided in the appended claims. For instance, references to busbars, relays, or sensor placements are illustrative of one implementation and should not be construed as limiting the invention to that particular form. Similarly, references to EVSE-based, HEMS-based, or standalone PCS configurations are representative of possible deployment options but are not exclusive of other architectures capable of achieving similar supervisory or protective functionality.

As further contemplated herein, features described in connection with one embodiment may be combined with, substituted for, or otherwise incorporated into other embodiments, even where such combinations or substitutions are not explicitly set forth. In certain instances, an embodiment may be described as advantageous, preferred, or more effective relative to other embodiments or to prior art approaches with respect to particular characteristics such as current limiting, system integration, or retrofit capability. However, one of ordinary skill will appreciate that in actual system implementations, design trade-offs may be made such that one or more individual features are modified, omitted, or adjusted to achieve desired overall system attributes. Such attributes may include, without limitation, manufacturability, serviceability, packaging, weight, size, durability, scalability, or other considerations. Accordingly, embodiments described as less desirable in view of a particular characteristic are nevertheless within the intended scope of the disclosure and may be beneficial for certain applications or system environments.

What is claimed is:

1. A home energy system comprising:
a distribution assembly including a power bus coupled to a utility grid interface, a home load interface, a distributed energy resource (DER) interface, and an electric vehicle (EV) interface;
measurement circuitry configured to obtain electrical parameters at each of the utility grid interface, the home load interface, the DER interface, and the EV interface;
relay switches coupled to at least the DER interface and the EV interface; and
a power control system (PCS) controller configured to:
when an aggregate parameter of the electrical parameters exceeds a value associated with the distribution assembly, issue a command to at least one of the DER or the EV to reduce active power exchange with the distribution assembly; and
when the aggregate parameter persists above the value for at least an interval after the command to reduce active power exchange, actuate a corresponding relay switch to electrically isolate the DER or the EV from the distribution assembly.

2. The home energy system of claim 1, wherein the command to reduce active power exchange with the distribution assembly comprises a command to reduce active power consumption by the EV.

3. The home energy system of claim 1, wherein the command to reduce active power exchange with the distribution assembly comprises a command to reduce active power output by the EV or the DER.

4. The home energy system of claim 1, wherein the command to reduce active power exchange with the distribution assembly comprises a command to reduce active power consumption by the EV and a command to reduce active power output by the DER.

5. The home energy system of claim 1, wherein the measurement circuitry comprises current sensors positioned at each of the utility grid, home load, DER, and EV interfaces.

6. The home energy system of claim 1, wherein the relay switch associated with the EV interface is positioned within an EVSE housing.

7. The home energy system of claim 1, wherein the value is a capacity constraint value that corresponds to a busbar ampacity rating of the distribution assembly.

8. The home energy system of claim 7, wherein the capacity constraint value corresponds to 120 percent of the busbar ampacity rating.

9. The home energy system of claim 1, wherein the PCS controller is housed within a home energy management system (HEMS) enclosure.

10. The home energy system of claim 1, wherein the PCS controller is housed within an electric vehicle supply equipment (EVSE) enclosure associated with the EV interface.

11. The home energy system of claim 1, wherein the PCS controller is provided in a standalone enclosure electrically and communicatively coupled to the distribution assembly.

12. A power control system (PCS) for a distribution assembly, the PCS comprising:
an input interface configured to receive electrical parameter data associated with a utility grid, a home load, a distributed energy resource (DER), and an electric vehicle (EV) connected to the distribution assembly;
a controller configured to:
when an aggregate electrical parameter derived from the electrical parameter data exceeds a value for the distribution assembly, issue a command to at least one of the EV and the DER to reduce active power exchange with the distribution assembly; and
when the aggregate electrical parameter persists above the value for at least an interval after a command to reduce active power exchange, actuate a relay switch associated with the EV or the DER.

13. The power control system of claim 12, wherein the input interface is configured to receive data via measurement lines electrically coupled to the distribution assembly.

14. The power control system of claim 12, wherein the controller is configured to actuate the relay switch associated with the DER when the DER continues to export power for at least the interval after the command to reduce active power exchange.

15. The power control system of claim 12, wherein the controller is configured to actuate the relay switch associated with the EV when the EV continues to exchange power for at least the interval after the command to reduce active power exchange.

16. The power control system of claim 12, wherein the interval is within a range of 100 milliseconds to 10 seconds.

17. The power control system of claim 12, wherein the controller and input interface are housed within a HEMS enclosure, within an EVSE housing, or within a standalone housing.

18. A method of controlling energy flow in a home energy system, the method comprising:
when an aggregate electrical parameter associated with a distribution assembly exceeds a value of the distribution assembly, commanding at least one of a distributed energy resource (DER) and an electric vehicle (EV) to reduce active power exchange with the distribution assembly; and
when the aggregate electrical parameter persists above the value for at least an interval after the commanding, opening a relay switch to electrically isolate the DER or the EV from the distribution assembly.

19. The method of claim 18, wherein commanding the EV to reduce active power exchange with the distribution assembly comprises:
reducing a power contribution by the EV when the EV is discharging to the distribution assembly; and
reducing a power consumption by the EV when the EV is charging through the distribution assembly.

20. The method of claim 18, wherein opening the relay switch comprises at least one of:
opening a first relay switch positioned between the distribution assembly and an electric vehicle supply equipment (EVSE) to electrically isolate the EVSE from the distribution assembly; and
opening a second relay switch positioned between the EVSE and the EV to electrically isolate the EV from the EVSE.
